(19) United States
(12) Patent Application Publication
(10) Pub. No.: US 2026/0291117 A1
(43) Pub. Date: Sep. 24, 2026

(54) CONNECTOR

(71) Applicant: Yazaki Corporation, Tokyo (JP)

(72) Inventors: Masaaki IWABE, Shizuoka (JP); Masaki OTA, Shizuoka (JP)

(73) Assignee: Yazaki Corporation, Tokyo (JP)

(21) Appl. No.: 19/539,254

(22) Filed: Feb. 13, 2026

(30) Foreign Application Priority Data
Mar. 19, 2025 (JP) 2025-044437

(51) Int. Cl. H01R 13/52

(52) U.S. Cl. CPC H01R 13/5202

(57) ABSTRACT

The connector includes a housing that mates with a mating connector, a cover attached to the housing, and a packing that cuts off water between the housing and the cover. The housing includes a housing-side surrounding wall surrounding the packing, and a housing-side water cut-off surface formed continuously with the housing-side surrounding wall and extending in a direction intersecting an assembly direction of the packing. The cover includes a cover-side surrounding wall sandwiching and surrounding the packing between it and the housing-side surrounding wall, and a cover-side water cut-off surface formed continuously with the cover-side surrounding wall and extending in the direction intersecting the assembly direction. The packing contacts the housing-side water cut-off surface and the cover-side water cut-off surface to cut off water.

### CROSS-REFERENCE TO RELATED APPLICATIONS

The present application claims priority to and incorporates by reference the entire contents of Japanese Patent Application No. 2025-044437 filed in Japan on Mar. 19, 2025.

### BACKGROUND OF THE INVENTION

### 1. Field of the Invention

The present invention relates to a connector.

### 2. Description of the Related Art

Conventional connectors are known, including a connector with a cover attached to an opening of a housing described in JP 2022-181650 A, for example. This connector includes a packing that cuts off water between the housing and the cover. The packing is placed between two walls formed on the cover to cut off water between the connector and the housing.

Such a connector has room for improvement in terms of downsizability. In the connector described above, for example, the water cut-off structure of the housing and the cover requires a certain space in a direction intersecting the mating direction of the housing and the cover to place the packing between the two walls of the cover. Therefore, to downsize the connector, it is desirable to develop a technique for making the water cut-off structure of the housing and the cover compact.

### SUMMARY OF THE INVENTION

An object of the present invention is to provide a connector that can be downsized by making a water cut-off structure of a housing and a cover compact.

In order to achieve the above mentioned object, a connector according to one aspect of the present invention includes a housing that mates with a mating connector; a cover attached to the housing; and a packing that cuts off water between the housing and the cover, wherein the housing comprises a housing-side surrounding wall surrounding the packing and a housing-side water cut-off surface formed continuously with the housing-side surrounding wall and extending in a direction intersecting an assembly direction of the packing, the cover comprises a cover-side surrounding wall sandwiching and surrounding the packing between the cover-side surrounding wall and the housing-side surrounding wall and a cover-side water cut-off surface formed continuously with the cover-side surrounding wall and extending in the direction intersecting the assembly direction, and the packing contacts the housing-side water cut-off surface and the cover-side water cut-off surface to cut off water.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a connector according to an embodiment;

FIG. 2 is an exploded perspective view of the connector according to the embodiment;

FIG. 3 is an exploded perspective view of the connector according to the embodiment;

FIG. 4 is an enlarged view of a housing of the connector according to the embodiment;

FIG. 5 is an enlarged view of a cover of the connector according to the embodiment;

FIG. 6 is an enlarged view of the cover and a packing of the connector according to the embodiment; and

FIG. 7 is a sectional view indicating the size of the connector according to the embodiment and the connector according to a comparative example.

### DETAILED DESCRIPTION OF THE PREFERRED EMBODIMENTS

Exemplary embodiments according to the present invention are described below in greater detail with reference to the drawings. The present invention is not limited by the embodiments. Components described in the embodiments below include components substitutable and easy to substitute by those skilled in the art or components substantially identical therewith.

### Embodiments

The present embodiment relates to a connector. In the following description, a first direction, a second direction, and a third direction intersect one another, and the first direction is referred to as "extension direction X", the second direction as "array direction Y", and the third direction as "assembly direction Z". The extension direction X, the array direction Y, and the assembly direction Z are orthogonal to one another. Being orthogonal herein includes being substantially orthogonal. The extension direction X is an extension direction of some wires. The array direction Y is an array direction of some wires. The assembly direction Z corresponds to a direction in which a cover is attached to a housing. Unless otherwise noted, each direction used in the following description indicates the direction when the parts are assembled with one another.

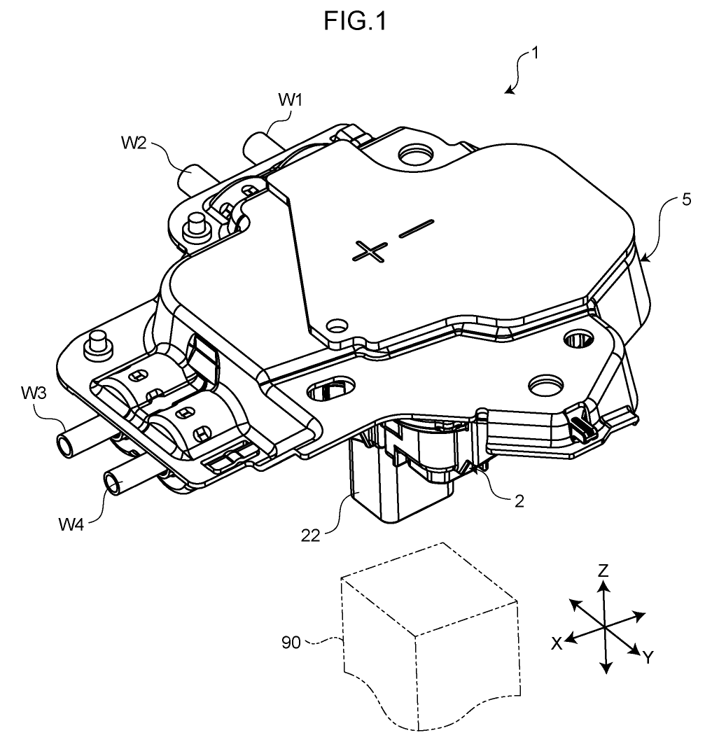

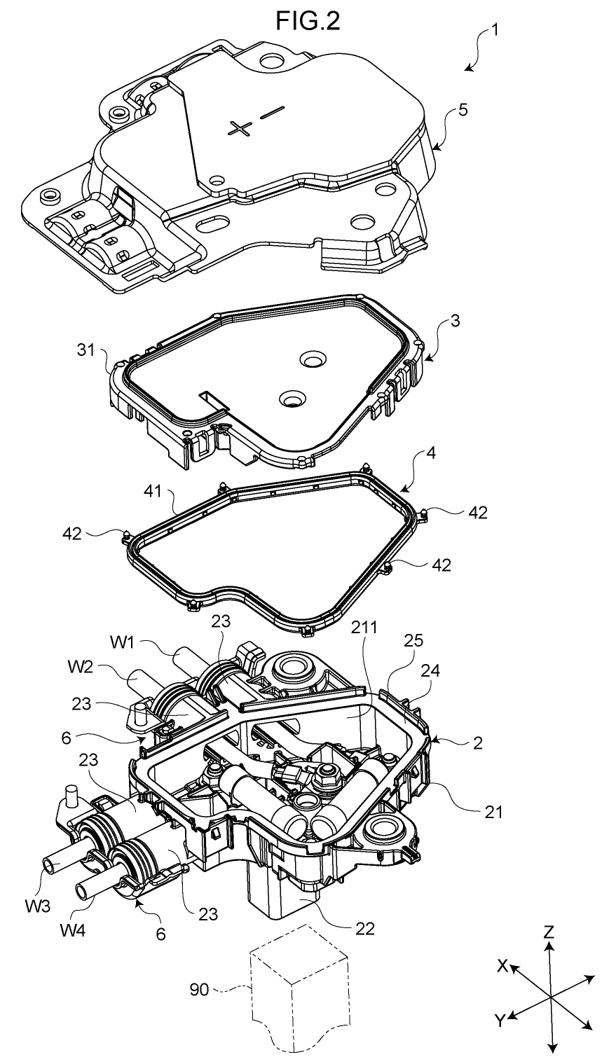

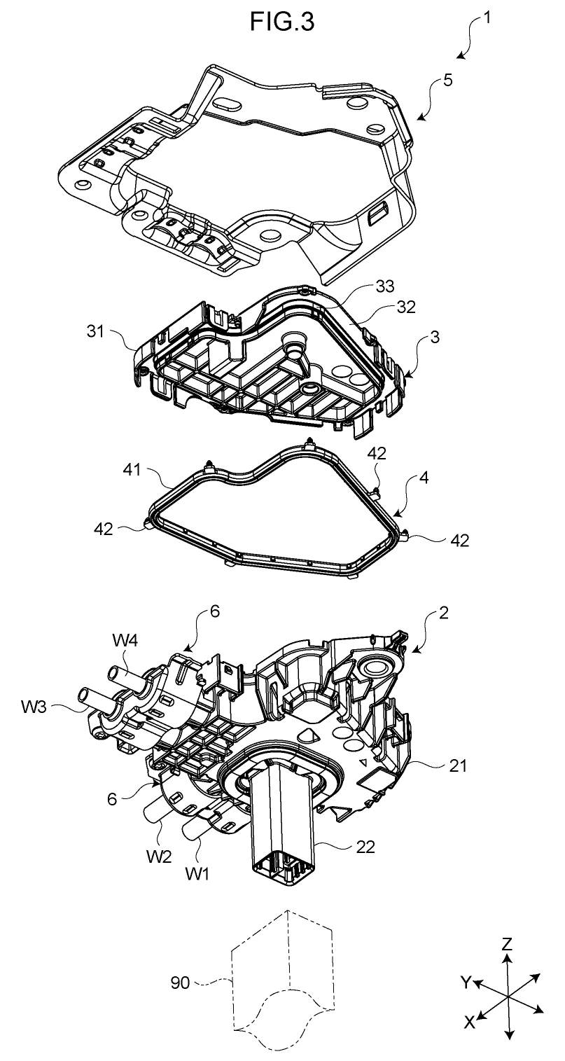

As illustrated in FIGS. 1 to 3, a connector 1 is a part connected to a mating connector 90 and is used, for example, by being mounted on a vehicle and incorporated with a wire harness routed in the vehicle. The wire harness herein is, for example, a component obtained by bundling wiring materials used for power supply and signal communications as an assembly part and connecting the wiring materials to devices mounted on the vehicle by the connector 1 or the like to connect the devices. The wire harness includes, for example, a plurality of wires W1, W2, W3, and W4, the connector 1 into which the ends of the wires W1, W2, W3, and W4 are drawn, and the mating connector 90 electrically and mechanically connected to the connector 1. The wire harness may also include various other components, such as grommets, protectors, and fixtures.

The connector 1 includes a housing 2, a cover 3, and a packing 4. The housing 2 is a part mating with the mating connector 90 and is formed of insulating resin material, for example. The housing 2 includes a housing body 21, a mating part 22, and wire insertion parts 23. The housing body 21 is formed in a box shape with an opening 211. The housing body 21, for example, has a concave polygonal sectional shape in a direction intersecting the assembly direction Z, and one of the interior angles of the sectional shape is larger than 180 degrees and smaller than 360 degrees. Specifically, the housing body 21 has a concave heptagonal sectional shape in the direction intersecting the assembly direction Z. The concave polygon may be a substantially concave polygon, and the concave heptagon may be a substantially concave heptagon. The length of the housing body 21 in the assembly direction Z is shorter than that in the extension direction X and the array direction Y. The opening 211 is formed by opening one surface of the housing body 21 in the assembly direction Z. The shape of the opening 211 is, for example, a concave polygon one of the interior angles of which is larger than 180 degrees and smaller than 360 degrees. The sectional shape of the housing body 21 may be a shape other than a concave polygon, such as a rectangle.

The mating part 22 protrudes from the housing body 21 in the assembly direction Z. The mating part 22 is formed in a square cylindrical shape extending in the assembly direction Z. The inside of the mating part 22 is provided with a plurality of male terminals, for example.

The wire insertion part 23 is formed protruding from the side surface of the housing body 21, and four wire insertion parts 23 are provided according to the number of wires W1 to W4. The wire insertion parts 23 are arranged in pairs. The pairs of the wire insertion parts 23 are provided in directions intersecting each other. For example, one of the pairs of the wire insertion parts 23 is provided protruding along the extension direction X, and the other of the pairs of the wire insertion parts 23 is provided protruding along the array direction Y.

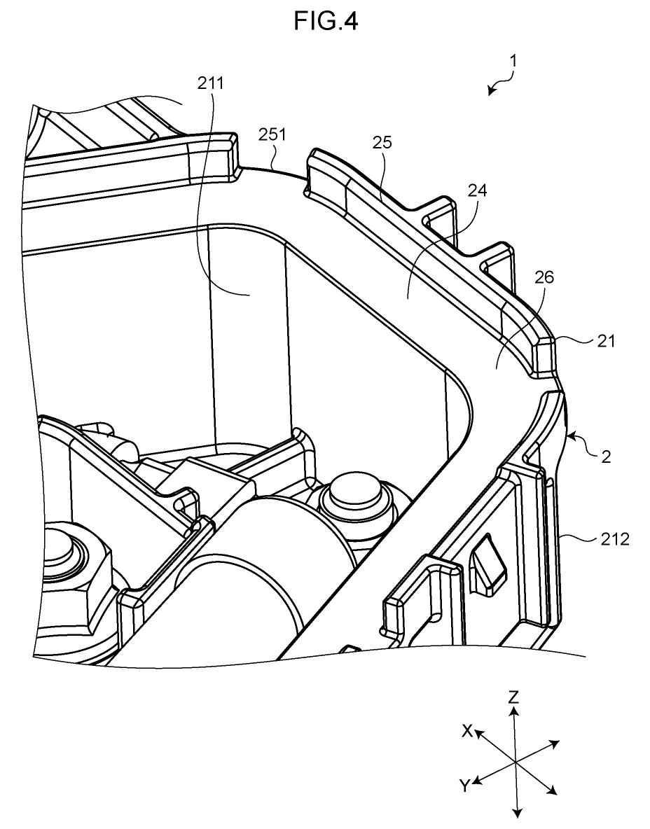

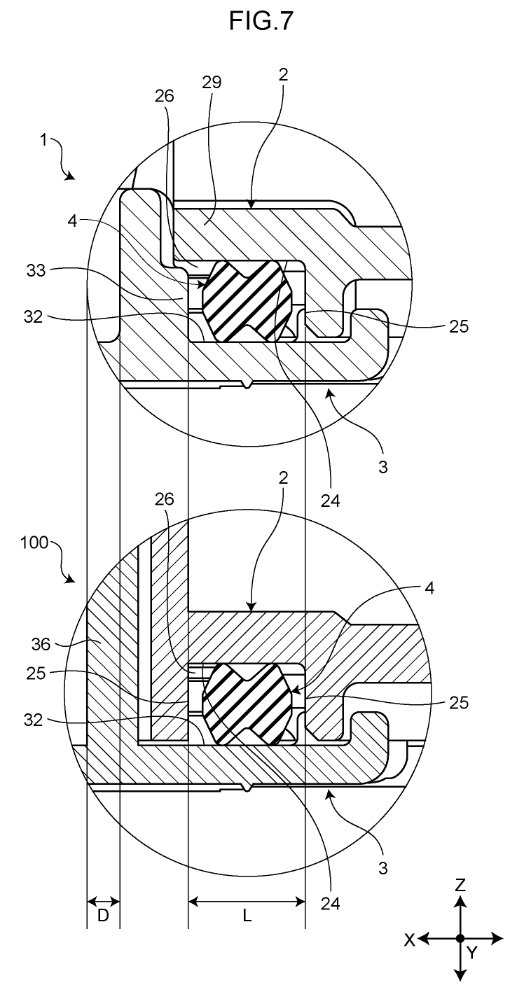

As illustrated in FIG. 4, the housing 2 includes a housing-side water cut-off surface 24 and a housing-side surrounding wall 25. The housing-side water cut-off surface 24 and the housing-side surrounding wall 25 are parts formed on the housing body 21 to hold the packing 4 and form a storage chamber 26 (refer to FIG. 7) for the packing 4. The housing-side water cut-off surface 24 and the housing-side surrounding wall 25 are formed along the outer end of the opening 211. The housing-side water cut-off surface 24 is a surface that extends in a direction intersecting the assembly direction Z and extends along the outer end of the opening 211. The housing-side water cut-off surface 24 is formed at the upper end of a side wall 212 of the housing body 21, for example. The housing-side surrounding wall 25 is a wall part protruding upward from the housing-side water cut-off surface 24 in the assembly direction Z. For example, the housing-side surrounding wall 25 is provided at a position closer to the outer side of the housing-side water cut-off surface 24 and covers the outer periphery of the packing 4. In other words, the housing-side water cut-off surface 24 and the housing-side surrounding wall 25 are continuously formed in an L-shaped section.

The housing-side surrounding wall 25 has a plurality of notches 251 formed at intervals in the extension direction. The notch 251 is a space for inserting a protruding piece 42 formed on the packing 4.

In FIGS. 1 to 3, the cover 3 is a lid member that covers the opening 211 of the housing 2 and is formed according to the shape and size of the opening 211. The cover 3 is formed in a concave polygonal shape, for example, and has such a size that covers the opening 211, the housing-side water cut-off surface 24, and the housing-side surrounding wall 25 of the housing 2.

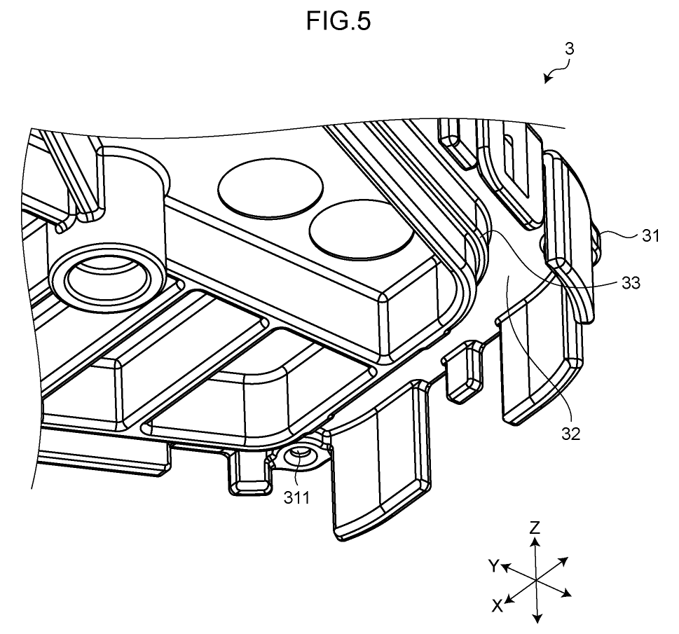

As illustrated in FIG. 5, the cover 3 includes a cover body 31, a cover-side water cut-off surface 32, and a cover-side surrounding wall 33. The cover body 31 is a plate-like part having a concave polygonal outline. The cover-side water cut-off surface 32 and the cover-side surrounding wall 33 are parts formed on the cover body 31 to hold the packing 4 and form the storage chamber 26 (refer to FIG. 7) for the packing 4. The cover-side water cut-off surface 32 and the cover-side surrounding wall 33 are formed along the outer end of the cover body 31. For example, the cover-side water cut-off surface 32 is provided facing the housing-side water cut-off surface 24. In other words, the cover-side water cut-off surface 32 is formed on the lower surface of the cover body 31, extends in a direction intersecting the assembly direction Z, and extends along the outer end of the cover body 31. The cover-side surrounding wall 33 is a wall part protruding downward from the cover-side water cut-off surface 32 in the assembly direction Z. For example, the cover-side surrounding wall 33 is provided at a position closer to the inner side of the cover-side water cut-off surface 32 and covers the inner periphery of the packing 4. In other words, the cover-side water cut-off surface 32 and the cover-side surrounding wall 33 are continuously formed in an L-shaped section.

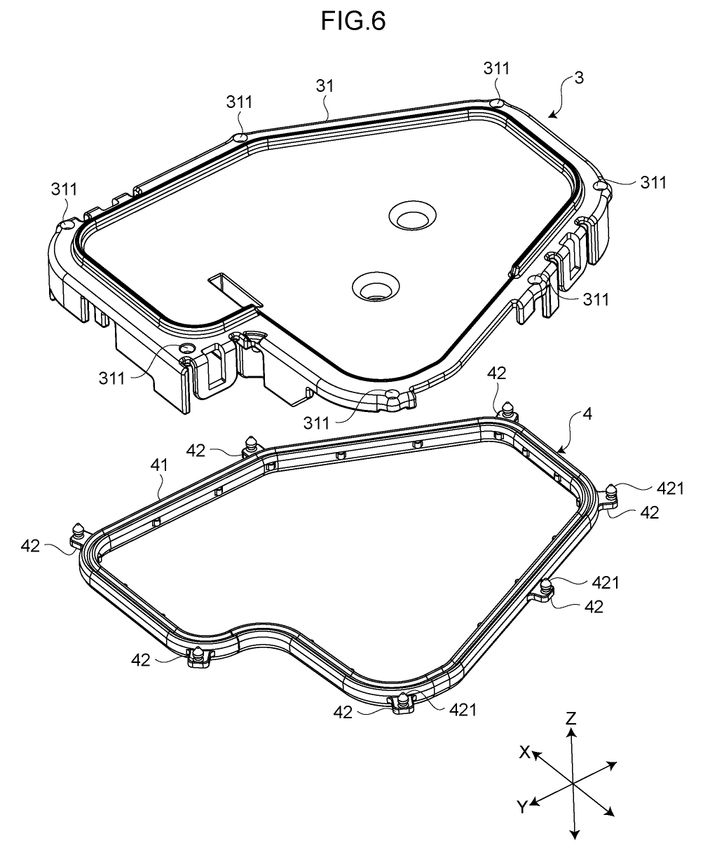

As illustrated in FIG. 6, the packing 4 is a water cut-off member that cuts off water between the housing 2 and the cover 3, and is formed as an annular member made of elastic material, such as rubber and elastomer. The packing 4 is formed according to the shape of the opening 211, for example, and is formed in a concave polygonal annular shape. The packing 4 includes a packing body 41 and protruding pieces 42. The packing body 41 is a part serving as a water cut-off member and is formed in an annular shape. The protruding piece 42 is a part protruding outward from the annular part of the packing body 41, and a plurality of protruding pieces 42 are provided at intervals. The protruding piece 42, for example, engages with the cover 3 and prevents the packing 4 from moving between the housing 2 and the cover 3. The protruding piece 42 includes an engaging part 421 protruding toward the cover 3. The engaging part 421 engages with an engaged part 311 formed on the cover body 31 of the cover 3, and the packing 4 is fixed to the cover 3. The engaged part 311 is, for example, a hole through which the engaging part 421 can be inserted. A plurality of engaged parts 311 are provided according to the number of protruding pieces 42 at positions corresponding to the positions of the engaging parts 421.

As illustrated in FIGS. 1 to 3, the connector 1 includes an upper shell 5 and a lower shell 6. The upper shell 5 is a shielding member provided to cover the cover 3 and the housing 2. The upper shell 5 is a plate-like member and is formed larger than the cover 3. The upper shell 5 is disposed to overlap the cover 3 from the outside. The lower shell 6 is provided to cover the wire insertion part 23. For example, two lower shells 6 are provided to cover the respective pairs of the wire insertion parts 23. The lower shell 6 is composed of two arc parts arranged side by side and sandwiches and covers the wire insertion parts 23 between it and the upper shell 5.

Next, the water cut-off structure of the connector 1 according to the present embodiment is described.

As illustrated in FIG. 7, the storage chamber 26 is formed by the housing 2 and the cover 3, and the packing 4 placed in the storage chamber 26 cuts off water between the housing 2 and the cover 3. FIG. 7 illustrates the water cut-off structure of the connector 1 according to the present embodiment and that of a connector 100 according to a comparative example and indicates the difference in size between the water cut-off structures. In the connector 1, the storage chamber 26 is formed by attaching the cover 3 to the housing 2. In other words, the storage chamber 26 having a rectangular section is formed by the housing-side water cut-off surface 24 and the housing-side surrounding wall 25 of the housing 2 and the cover-side water cut-off surface 32 and the cover-side surrounding wall 33 of the cover 3. The packing 4 is placed in the storage chamber 26 and contacts the housing-side water cut-off surface 24 and the cover-side water cut-off surface 32 to cut off water between the housing 2 and the cover 3.

In the connector 100 according to the comparative example, the storage chamber 26 having a rectangular section is formed by the housing-side water cut-off surface 24 and two housing-side surrounding walls 25 of the housing 2 and the cover-side water cut-off surface 32 of the cover 3. In other words, the two housing-side surrounding walls 25 extend from the housing 2 and cover the sides of the packing 4. The storage chamber 26 of the connector 100 is a space having the same width L as the storage chamber 26 of the connector 1. The water cut-off structure of the connector 100, however, requires a support 36 that supports the two housing-side surrounding walls 25. As a result, the connector 100 has a larger water cut-off structure than the connector 1 by a difference D in width due to the support 36. In other words, the connector 1 can support and position the housing-side surrounding wall 25 and the cover-side surrounding wall 33 with respect to each other by bringing a water cut-off part 29 having the housing-side water cut-off surface 24 into contact with the cover-side surrounding wall 33 without requiring the support 36 of the connector 100. Therefore, in the connector 1 according to the present embodiment, the water cut-off structure can be made compact.

As described above, the connector 1 according to the present embodiment surrounds and holds the packing 4 between the housing-side surrounding wall 25 and the cover-side surrounding wall 33. Therefore, the water cut-off structure that holds the packing 4 can be made compact, thereby downsizing the connector 1.

In the connector 1 according to the present embodiment, the housing-side surrounding wall 25 and the housing-side water cut-off surface 24 are continuously formed in an L-shaped section, and the cover-side surrounding wall 33 and the cover-side water cut-off surface 32 are continuously formed in an L-shaped section. Therefore, the storage chamber 26 for the packing 4 can be formed by the housing-side surrounding wall 25, the housing-side water cut-off surface 24, the cover-side surrounding wall 33, and the cover-side water cut-off surface 32. Thus, the connector 1 can securely hold the packing 4 and appropriately cut off water by the packing 4.

The connector according to the present invention is not limited to the embodiment described above, and various modifications can be made within the scope of the claims. The connector 1 according to the present embodiment may be configured by combining the components of the embodiment and modifications described above as appropriate.

While the connector 1 according to the embodiment described above is mounted on a vehicle, for example, it may be used for objects other than vehicles.

In the connector according to the present embodiment, the water cut-off structure of the housing and the cover can be made compact, thereby downsizing the connector.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a housing that mates with a mating connector;
a cover attached to the housing; and
a packing that cuts off water between the housing and the cover, wherein
the housing comprises a housing-side surrounding wall surrounding the packing and a housing-side water cut-off surface formed continuously with the housing-side surrounding wall and extending in a direction intersecting an assembly direction of the packing,
the cover comprises a cover-side surrounding wall sandwiching and surrounding the packing between the cover-side surrounding wall and the housing-side surrounding wall and a cover-side water cut-off surface formed continuously with the cover-side surrounding wall and extending in the direction intersecting the assembly direction, and
the packing contacts the housing-side water cut-off surface and the cover-side water cut-off surface to cut off water.

2. The connector according to claim 1, wherein
the housing-side surrounding wall and the housing-side water cut-off surface are continuously formed in an L-shaped section, and the cover-side surrounding wall and the cover-side water cut-off surface are continuously formed in an L-shaped section.
